(19) United States
(12) Patent Application Publication
(10) Pub. No.: US 2024/0349866 A1
(43) Pub. Date: Oct. 24, 2024

(54) Disposable Hygienic Straight Edge Shaving System

(71) Applicants: Ahmad Hamoud, Chicago, IL (US); Gus Hammond, Chicago, IL (US)

(72) Inventors: Ahmad Hamoud, Chicago, IL (US); Gus Hammond, Chicago, IL (US)

(21) Appl. No.: 18/136,648

(22) Filed: Apr. 19, 2023

(51) Int. Cl. A45D 27/22; A45D 27/29; B26B 21/10

(52) U.S. Cl. CPC A45D 27/225; A45D 27/29; B26B 21/10

(57) ABSTRACT

A system where disposable razors are attached to the holder and removed from it after shaving without contaminating the shaving instrument. With the rise of personal hygiene awareness, individuals are better off with a straight edge shaving system, that uses disposable razors. Traditional razors come with the concern that the razor handle is contaminated from the razor during the shaving time. When the barber removes the old razor and places the new one on the holder, the shaving cream from the previous customer would contaminate the holder, and even with a new razor, customers are often worried about the contamination reaching to the new razors and to their skin.

### CROSS-REFERENCE TO RELATED APPLICATIONS

At least one specification heading is required. Please delete this heading section if it is not applicable to your application. For more information regarding the headings of the specification, please see MPEP 608.01(a).

### BACKGROUND OF THE INVENTION

Straight Edge shaving is a professional service that has been a tradition for ages and still popular till modern times. With the rise of personal hygiene awareness, individuals are better off with a straight edge shaving system, that uses disposable razors.

Off course this is still available in the professional market and so many manufacturers have introduced many kinds and styles of disposable razors, but all of them share the same concern that the razor handle is contaminated from the razor during the shaving time. When the barber removes the old razor and places the new one on the holder, the shaving cream from the previous customer would contaminate the holder, and even with a new razor, customers are often worried about the contamination reaching to the new razors and to their skin.

According to the Hepatitis C Trust webpage [01], the hepatitis C virus can be transmitted from one person to another via tools and equipment, such as clippers, scissors, tweezers, and shaving equipment, used in barbers and hairdressers' shops. In another study on the spread of Hepatitis C and HIV in Pakistan, reported in Virology Journal [02], the authors again listed razor and a substantial factor in such disease spread. Besides razors, other personal items such as toothbrushes can also contribute to the spread of hepatitis and other infections [03].

For example, at the barber shop, the barber just used a straight-edge razor to shave the beard of customer A, and most likely small traces of blood from small skin cuts will contaminate the razor, which in turn, due to the shaving liquid, contaminates the holder. Even with new razor installed on the holder, the contaminated holder will transfer the contamination to the new razor and then to the blood stream of customer B via small skin cuts. Thus, these instruments must be constantly sanitized between uses to prevent the spread of diseases such as hepatitis C and HIV.

Several patents such as [04]-[08] were issued focusing on the style and design and very few focused on hygiene aspects such as [08], but no one offered a clear-cut solution to actually prevent the spread of contamination.

### SUMMARY OF THE INVENTION

The main idea of this invention is to stop the contamination spreading from an old razor just used on person A to a new razor to be used on person B, by not allowing the contamination to go to the holder.

In this invention, the system 100 is carefully designed, where disposable razors 250 are attached onto the holder 210 and removed from it without contaminating it. This is achieved by making the neck of the razor 252 so long so it extends all the latch 212 till it reaches the tip of the handle 211. This is, no matter how the shaving cream spreads on the razor 250, still it will not reach any part of the holder 210.

Inserting a new razor 250 is straightforward and it is achieved without touching it. The barber will hold the holder 210 from the handle 211 and insert the latch 212 through the cartridge opening 360 into the razor latch-hole 260 until it is fully inserted. Then the barber will pull out the holder 210 with the razor 250 mounted in place, which all together make the shaving instrument 200. The cartridge opening 360 of the cartridge box 310 is designed in a way that when the razor 250 is pulled out, the opening 360 becomes jammed (or blocked) 361 so that the razor cannot be pushed back. The barber is ready to use a fresh razor on a new customer.

To dispose the used razor 650, the barber will insert the used razor 650 of the shaving instrument 200 into the disposal box 610 through the special rectangular opening 670 of the disposal box 610. Once the whole razor 650 is all inside the box 610, the barber will hold the razor against the narrow side of the opening 670 and pull out the holder 210, causing the used razor 650 to be trapped inside the disposal box 610. This way the holder 210 is fully out without the contaminated used razor 650. Once the holder 210 is out and used razor 650 dropped inside the disposal box 610, the opening 670 blocks any used razors 650 to come out.

Of course for extra precaution, the barber can always keep the holder 210 extra sanitized by immersing it in alcohol jar. When the disposal box 610 if filled with used razors 650, the disposal box 610 is disposed and the used razors 650 are never used again.

### DESCRIPTION OF DRAWINGS

FIG. 1 is a side cutaway view of the Professional Disposable Hygienic Straight Edge Shaving System 100 and is comprised of three basic components, the shaving instrument 200, the razors cartridge box 300, and the razor disposal bin 600.

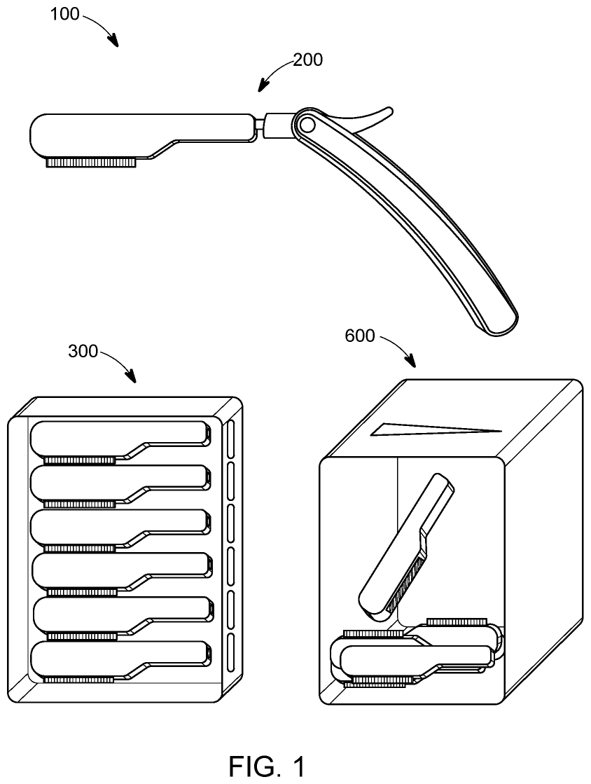

FIG. 2 shows a side view of the shaving instrument 200 is shown with its two parts separated, the holder 210 and the razor 250. The holder 210 is comprised of the handle 211 and the latch 212. The razor 250 is comprised of the body 251 holding the sharp edge razor 255, and the neck 252 with the latch-hole 260.

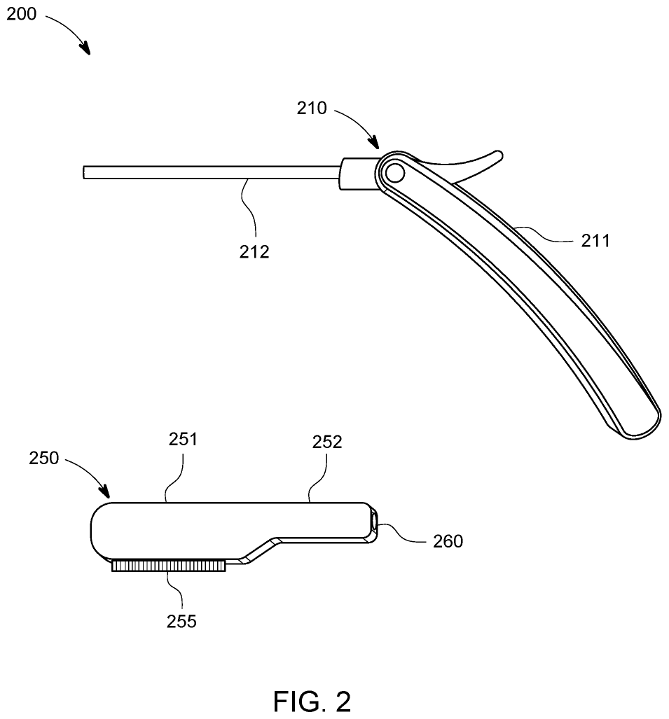

FIG. 3 is a side view of the razor cartridge 300, which is comprised of the container box 310, the special sealed cartridge opening 360 on the side on the box 310, and a stack of razors 250, where the latch-hole 260 lines up with the cartridge opening 360.

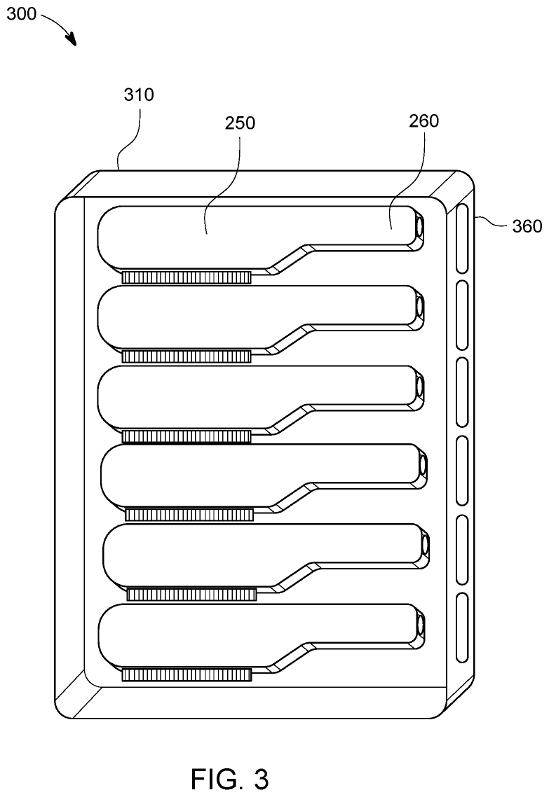

FIG. 4 is a side view of the razor dispensing process 400, where the latch 212 of the holder 210 is inserted into the razor's latch-hole 260 through the cartridge side opening 360

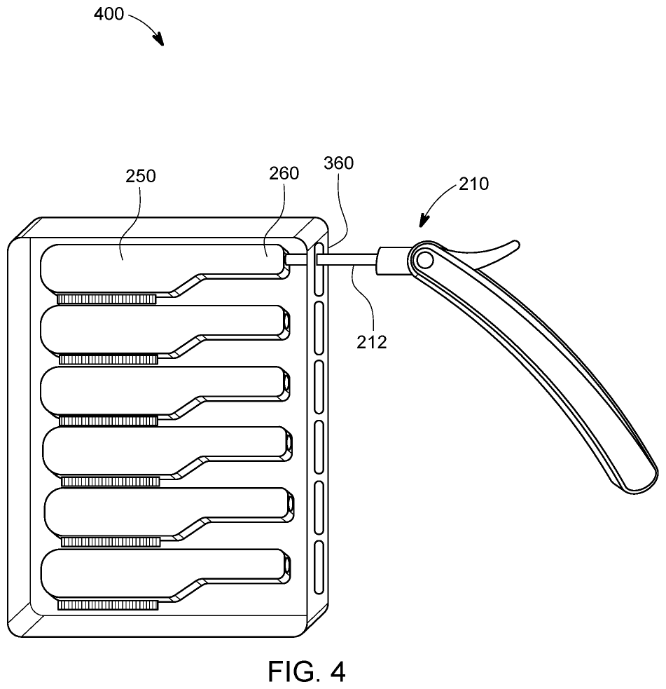

FIG. 5 the razor cartridge safety feature 500, where the cartridge side opening 360 gets blocked 361 once the shaving instrument 200 is pulled out from the cartridge 300.

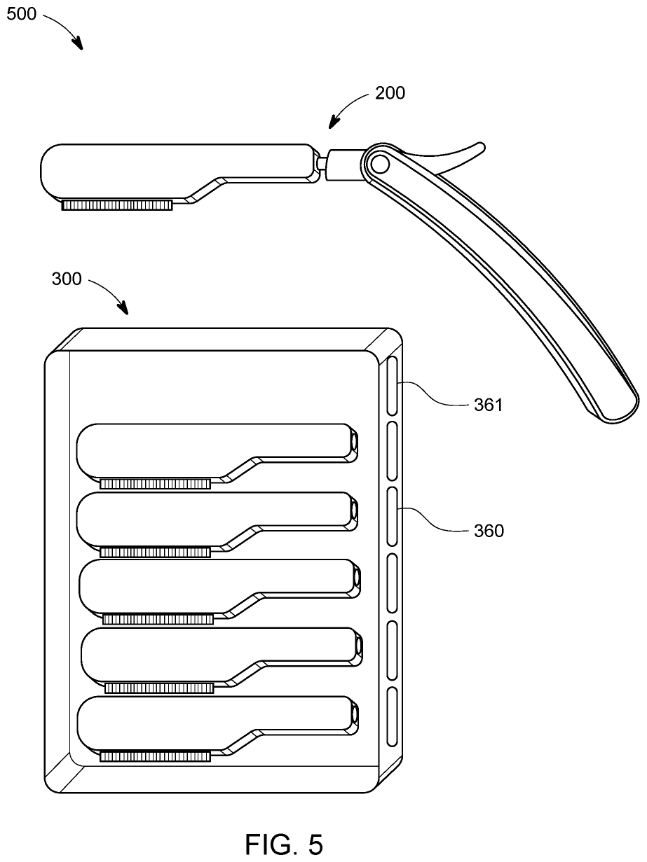

FIG. 6 the razor dispensing bin 600, which is comprised of disposal box 610 with special sealed triangular opening 670. When the shaving instrument 200 with the used razor 650 is inserted into the disposal box 610 via the special rectangular opening 670, and pulled out, the razor 650 is trapped inside the box 610 for permanent discard.

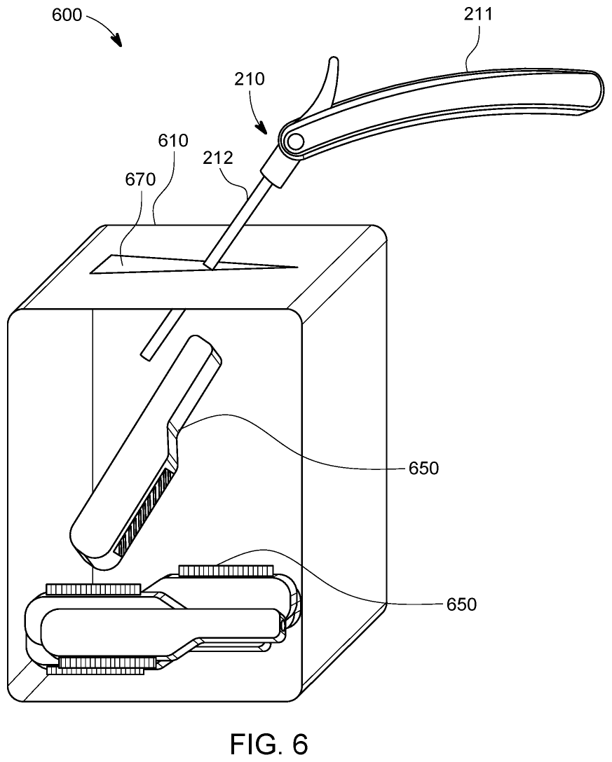

### REFERENCES

[01] http://www.hepctrust.org.uk/information/risk-factors/hairdressers-and-barbers
[02] https://virologyj.biomedcentral.com/articles/10.1186/1743-422X-8-102
[03] https://search.cdc.gov/search/?query=razor&dpage=1
[04] Patent: https://patents.google.com/patent/US917043A/en?oq=4665615
Inventor: Daniel W Gage
[05] https://patents.google.com/patent/US2192362A/en?oq=4665615
Inventor: Merlo Victor
[06] https://patents.google.com/patent/USD939772S1/en?oq=4665615
Inventors: Haviv Aizenkraft, and Ariel Grinspun
[07] https://patents.google.com/patent/USD525390S1/en?oq=4665615
Inventor: Joshua E. Barbieri
[08] https://patents.google.com/patent/US20140096395A1/en?oq=4665615
Inventor: John W. GRINER

1. A hygienic straightedge shaving system with disposable razors comprising of the shaving instrument, holder, disposal box, razor cartridge, handle, and the latch.

2. The hygienic straightedge shaving system with disposable razors comprising of the shaving instrument, holder, disposal box, handle, and the latch as in claim 1, wherein the razor comprises of a body, blade, long neck, and latch hole.

3. The hygienic straightedge shaving system with disposable razors comprising of the shaving instrument, holder, disposal box, handle, and the latch as in claim 1, wherein the razor cartridge comprises a container box.

4. The hygienic straightedge shaving system with disposable razors comprising of the shaving instrument, holder, disposal box, handle, and the latch as in claim 3, wherein the razor cartridge has a sealed cartridge opening on the side of the box.

5. The hygienic straightedge shaving system with disposable razors comprising of the shaving instrument, holder, disposal box, handle, and the latch as in claim 3, wherein the latch hole lines up with the stack of razors inside the box.

6. The hygienic straightedge shaving system with disposable razors comprising of the shaving instrument, holder, disposal box, handle, and the latch as in claim 1, wherein the disposal box has a sealed triangular opening on the top of the box.

7. The hygienic straightedge shaving system with disposable razors comprising of the shaving instrument, holder, disposal box, handle, and the latch as in claim 2, wherein the long neck covers the entire latch to prevent shaving cream from contaminating any part of the holder.

8. The hygienic straightedge shaving system with disposable razors comprising of the shaving instrument, holder, disposal box, handle, and the latch as in claim 1, wherein once a new razor is pulled out, the cartridge opening becomes sealed.

9. A method of using a hygienic straightedge shaving system with disposable razors comprising of the shaving instrument, holder, disposal box, razor cartridge, handle, and the latch.

10. The method of using a hygienic straightedge shaving system with disposable razors comprising of the shaving instrument, holder, disposal box, razor cartridge, handle, and the latch as in claim 9, wherein a fresh razor is installed on the holder by inserting the latch of the holder into the razor's latch hole through the cartridge side opening and a new razor is pulled out.

11. The method of using a hygienic straightedge shaving system with disposable razors comprising of the shaving instrument, holder, disposal box, razor cartridge, handle, and the latch as in claim 9, wherein a used razor can be disposed of by being placed into the disposal box via the rectangular opening.

12. The method of using a hygienic straightedge shaving system with disposable razors comprising of the shaving instrument, holder, disposal box, razor cartridge, handle, and the latch as in claim 11, wherein the used razor is held against the narrow side of the opening and the holder is pulled out, trapping the used razor inside the disposal box.
